(19) United States
(12) Patent Application Publication
(10) Pub. No.: US 2025/0068822 A1
(43) Pub. Date: Feb. 27, 2025

(54) METHOD OF DESIGNING LAYOUT OF SEMICONDUCTOR DEVICE AND SEMICONDUCTOR DEVICE LAYOUT DESIGN SYSTEM

(71) Applicant: SAMSUNG ELECTRONICS CO., LTD., Suwon-si (KR)

(72) Inventors: YUNHO CHOI, Suwon-si (KR); Jeong Min KIM, Suwon-si (KR)

(73) Assignee: SAMSUNG ELECTRONICS CO., LTD., Suwon-si (KR)

(21) Appl. No.: 18/603,905

(22) Filed: Mar. 13, 2024

(30) Foreign Application Priority Data
Aug. 21, 2023 (KR) 10-2023-0109367

(51) Int. Cl. G06F 30/398; G06F 30/392; G06F 115/02; G06F 119/06

(52) U.S. Cl. CPC G06F 30/398; G06F 30/392; G06F 2115/02; G06F 2119/06

(57) ABSTRACT

Provided is a method of designing a layout of a semiconductor device including a plurality of wiring layers, the method including verifying a power distribution network, the verifying of the power distribution network including designing a layout including a power wiring pattern, extracting a top layer wiring pattern and a next-top layer wiring pattern connected to bumps in the power wiring pattern, determining whether the top layer wiring pattern and the next-top layer wiring pattern are interconnected, and modifying the layout based on whether the top layer wiring pattern and the next-top layer wiring pattern are interconnected.

### CROSS-REFERENCE TO RELATED APPLICATIONS

This application claims priority to Korean Patent Application No. 10-2023-0109367, filed on Aug. 21, 2023, the disclosure of which is incorporated herein in its entirety by reference.

### BACKGROUND

Embodiments of the present disclosure relate to a method and a system of designing a layout of a semiconductor device.

A semiconductor device is defined by schematic data regarding various elements, such as a transistor, a resistor, and a diode. A designer may design an integrated circuit by setting a schematic diagram or schematic data of the integrated circuit to allow a circuit of the semiconductor device to perform a desired function. The schematic diagram includes various elements, such as a transistor, a resistor, and a diode and defines a connection relationship between the elements.

Since layout data of the circuit in the semiconductor device are generated based on the schematic data, layout-versus-schematic (LVS) verification may be performed to verify whether the layout data match the schematic data.

To verify a power distribution structure, for example, a power distribution network, in the semiconductor device using an existing LVS, a netlist extracted from a designed layout is compared with a file of a graphics design system GDS format to verify whether the netlist matches the file. However, this verification process is carried out in the form of verifying a connectivity of wirings for entire layers, and thus, a more simple and easier method to verify the power distribution network is required.

### SUMMARY

One or more embodiments provide a method and a system of designing a power distribution network with a minimum resistance in a simple and easy way.

According to an aspect of an embodiment, there is provided a method of designing a layout of a semiconductor device including a plurality of wiring layers, the method including verifying a power distribution network, the verifying of the power distribution network including designing a layout including a power wiring pattern, extracting a top layer wiring pattern and a next-top layer wiring pattern connected to bumps in the power wiring pattern, determining whether the top layer wiring pattern and the next-top layer wiring pattern are interconnected, and modifying the layout based on whether the top layer wiring pattern and the next-top layer wiring pattern are interconnected.

According to another aspect of an embodiment, there is provided a method of designing a layout of a semiconductor device including n wiring layers, where n is a natural number equal to or greater than 2, sequentially on bumps, the method including designing the layout including a power wiring pattern, extracting, based on an open occurring in wirings connected to the bumps from a first wiring pattern to a (p−2)th wiring pattern, where p is a natural number greater than 3, in the power wiring pattern, the wiring patterns from the first wiring pattern to a p-th wiring pattern to determine whether the bumps are interconnected with the wiring patterns from the first wiring pattern to the p-th wiring pattern, extracting, based on the open not occurring, the first wiring pattern and a second wiring pattern to determine whether the bumps are interconnected with the first wiring pattern and second wiring pattern, and modifying the layout based on whether the bumps are interconnected with the first wiring pattern and second wiring pattern.

According to another aspect of an embodiment, there is provided a layout design system for a semiconductor device including a plurality of wiring layers including a power distribution network, including at least one processor configured to design a layout design, verify the designed layout, and generate verified layout data, wherein the processor is further configured to extract a portion of wiring layers connected to bumps among the wiring layers and verify the extracted wiring layers such that the power distribution network has a minimum resistance when verifying the designed layout.

### BRIEF DESCRIPTION OF DRAWINGS

The above and other objects and features will become apparent by describing in detail embodiments thereof with reference to the accompanying drawings, in which:

FIG. 1 is a block diagram illustrating a layout design system according to an embodiment;

FIG. 2 is a block diagram illustrating a processor in a layout design system for a semiconductor device according to embodiments;

FIG. 3 is a flowchart illustrating a method of designing a layout by a processing unit in a layout design system for a semiconductor device according to embodiments;

FIG. 4 is a block diagram illustrating an LVS engine in an analyzer;

FIG. 5 is a flowchart illustrating a power distribution network (PDN) verification process in a layout design method according to an embodiment;

FIG. 6A is a plan view conceptually illustrating a relationship between bumps and wirings in a semiconductor device having multiple wiring layers;

FIG. 6B is a cross-sectional view taken along a line A-A′ of FIG. 6A;

FIG. 7 is a plan view conceptually illustrating only a power wiring part of a semiconductor device except a signal wiring part;

FIGS. 8A and 8B are a perspective view and a cross-sectional view conceptually illustrating a layout for each wiring layer of a power pattern when the designed layout of the power pattern passed a verification process;

FIG. 9 is a perspective view and a cross-sectional view conceptually illustrating a layout for each layer of a power pattern when the designed layout of the power pattern failed a verification process;

FIG. 10 is a flowchart illustrating a PDN verification process when there is an open portion in wiring patterns of a top layer and a next-top layer according to an embodiment; and

FIG. 11 is a flowchart illustrating a method of manufacturing a semiconductor device.

### DETAILED DESCRIPTION

The present disclosure may be variously modified and realized in many different forms, and thus specific embodiments will be exemplified in the drawings and described in detail hereinbelow. However, the present disclosure should not be limited to the specific disclosed forms, and be construed to include all modifications, equivalents, or replacements included in the spirit and scope of the present disclosure. Embodiments described herein are example embodiments, and thus, the disclosure is not limited thereto.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

Hereinafter, embodiments will be described in more detail with reference to accompanying drawings.

The embodiments of the present disclosure relate to a layout design system for a semiconductor device and a layout design method using the layout design system. For example, the layout design system according to the embodiments of the present disclosure is configured to design a layout that may more efficiently implement a power distribution network in various semiconductor devices, especially the semiconductor device including various circuits.

The layout design system according to the embodiments has a function of designing a layout of the semiconductor device by building the layout based on circuit diagrams and layout design information. According to the embodiments, a process of designing the layout of the semiconductor device may be a computer implementation process to design the circuits.

In the following descriptions, the layout design refers to designing layout data based on the circuit diagrams and the layout design information. A circuit diagram may be a drawing in which active elements such as transistors and diodes, passive elements such as capacitors and resistors, and their connection relationships are represented by figures and lines. In the embodiments, the layout data refer to information about a shape and an arrangement of semiconductor layers, conductor layers, and the like, which are transferred to a mask used to manufacture the semiconductor device. The layout design information includes a cell library, a design rule, etc.

According to embodiments, the layout design system includes a processor that designs a layout of a power wiring pattern by verifying whether wiring patterns of a power supply unit are interconnected, and this will be described in detail below.

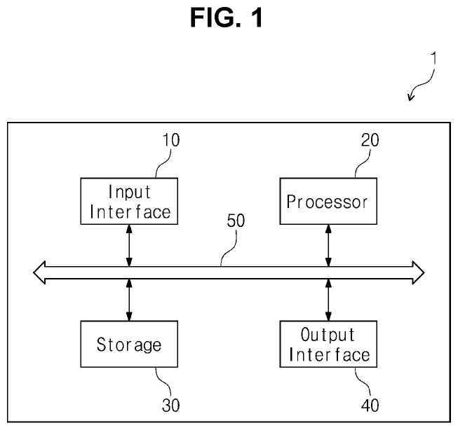

FIG. 1 is a block diagram illustrating a layout design system 1 according to an embodiment.

Referring to FIG. 1, the layout design system 1 may include an input interface 10, a processor 20, a storage 30, an output interface 40, and a transfer unit 50.

The transfer unit 50 may transmit and receive information between the input interface 10, the processor 20, the storage 30, and the output interface 40. The transfer unit 50 may be implemented by a data bus, for example.

The input interface 10 may receive the information from an outside thereof. The received information may be transferred to the processor 20, the storage 30, and the output interface 40 through the transfer unit 50. The information input to the input interface 10 may include a circuit diagram, layout design information, etc. The input interface 10 and the output interface 40 may each include at least one of a display device, a keyboard, a mouse, a touch sensor, a scanner, a printer, a microphone, a camera, etc. Further, the input interface 10 may include a modem, a WiFi chip and related software and/or firmware.

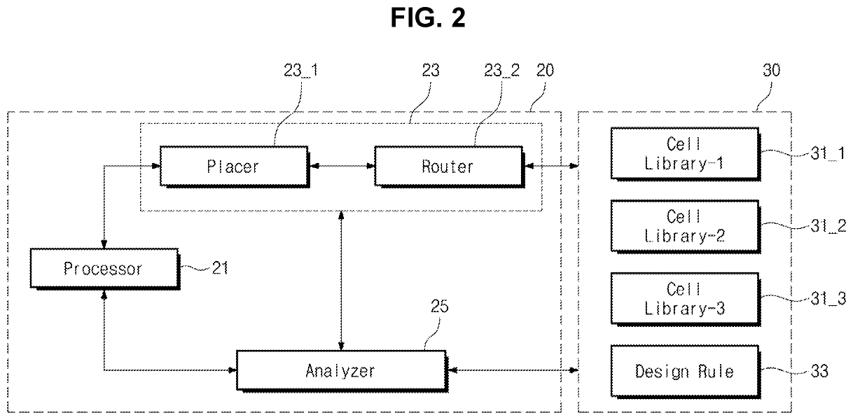

The processor 20 may design a layout of a semiconductor device and may generate layout data using the information provided from the input interface 10 and the storage 30. The processor 20 may also review a suitability of the designed layout through verification and may modify the layout when the layout is unsuitable. The processor 20 may change the circuit diagram and the layout design information to enable design of various layouts. The processor 20 may include processors that interprets and executes instructions from various programs to process various data and to control programs. The processor 20 may include one or more processors as described in reference to FIG. 2 below.

The storage 30 may store programs executed by the processor 20. The storage 30 may also store information input from the input interface 10, information extracted from a database, and information to be output to the output interface 40. The storage 30 may include various memories to store the information, for example, a volatile memory and/or a non-volatile memory.

The processor 20 may provide the layout data to the storage 30 and the output interface 40.

The storage 30 may store the cell library and the design rule. The storage 30 may also store the layout data generated by the processor 20 and the information from the input interface 10. The processor 20 may include a storage provided therein, and the storage provided in the processor 20 may include the storage 30 therein or may include a storage separate from the storage 30.

According to an embodiment, the storage 30 may include a volatile memory such as a random access memory (RAM) and/or a non-volatile memory such as a read only memory (ROM). In detail, the storage 30 may include, for example, a volatile memory such as a dynamic random access memory (DRAM), a static random access memory (SRAM), etc. or a non-volatile memory such as a resistive random access memory (ReRAM), a magnetoresistive memory, e.g., a phase-change random access memory (PRAM), a ferroelectric random access memory (FeRAM), and a magneto-resistive random access memory (MRAM), or a flash memory. According to an embodiment, ROM may store basic input/output system BIOS and a firmware. The ROM may include a mask ROM, a one-time programmable read only memory (OTPROM), or an erasable programmable read only memory (EPROM). The EPROM may include an ultraviolet erasable programmable read only memory (UVEPROM), which enables erasing of memory data by irradiating an ultraviolet ray, an electrically erasable programmable read only memory (EEPROM), a flash memory, etc. The storage 30 may include a recording media drive such as a hard disk drive HDD and a solid state drive SSD.

The output interface 40 may supply the layout data generated by the processor 20 to the outside.

The layout design system may perform at least a portion of a design operation for the semiconductor device when designing the layout of the semiconductor device. The layout design system may be implemented as an integrated semiconductor device and, accordingly, may also be referred to as a design device. The layout design system may be provided as a dedicated device configured to design an integrated circuit of the semiconductor device, but may also be a computer to operate various simulation tools or design tools.

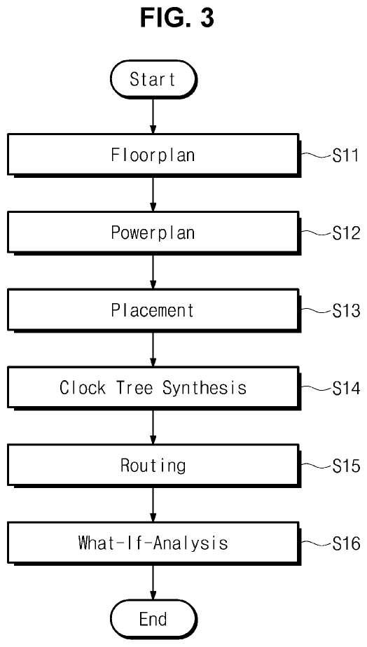

FIGS. 2 and 3 are views illustrating the processor 20 in the layout design system 1 for the semiconductor device shown in FIG. 1. In detail, FIG. 2 is a block diagram illustrating the processor 20 in the layout design system 1 of FIG. 1 according to embodiments, and FIG. 3 is a flowchart illustrating a method of designing a layout of a semiconductor device by the processor 20 according to embodiments.

Referring to FIGS. 2 and 3, the designing process of the layout of the semiconductor device may be executed by the layout design system including the processor 20. The layout designing process is a process of designing the layout of the circuits of the semiconductor device. The layout design system may include a program including a plurality of commands executed by a processor 21.

The designing process of the layout of the semiconductor device may include a floorplan process (S11), a powerplan process (S12), a placement process (S13), a clock tree synthesis (CTS) process (S14), a routing process (S15), and a what-if-analysis process (S16).

The floorplan process (S11) may be a physical design process including cutting and shifting a logically designed schematic circuit. A memory or a functional block may be arranged in the floorplan process (S11). In this process, for example, functional blocks to be placed adjacent to each other may be identified, and spaces may be allocated for the functional blocks in consideration of available space, required performance, and the like. For example, the floorplan process (S11) may include a process of producing a site-row and a process of forming a metal routing track in the produced site-row. The site-row is a frame in which standard cells stored in the cell library are disposed according to the design rule. The metal routing track is a virtual line along which routings are to be formed later.

The powerplan process (S12) may be a process of disposing power wiring patterns connecting a local power, for example, a power or ground, to the functional blocks arranged in the floorplan process (S11). The power wiring patterns may be generated in the form of a network such that the power is uniformly supplied to an entire chip in the powerplan process (S12). As an example, the power wiring patterns, i.e., power patterns connecting the power and/or ground patterns connecting the ground, may be generated in the powerplan process (S12). In particular, in the case where the semiconductor device includes multiple wiring layers including wirings, the power patterns and the ground patterns may be generated according to each wiring layer in the powerplan process (S12). The power wiring patterns may include power rails and, in this process, the power wiring patterns may be generated in a network form through various rules.

The placement process (S13) may be a process of arranging patterns of elements included in the functional block and may include a process of arranging the standard cells. For example, in embodiments, each standard cell may include semiconductor elements and power wiring patterns and signal line patterns, which are connected thereto. The power wiring patterns and the signal line patterns may include a power transmission line connecting a power or a ground and a signal transmission line transmitting a control signal, an input signal, or an output signal. This process may define a shape or a size of a pattern for constituting a transistor and wirings, which are to be actually formed on a semiconductor substrate. For example, in order to form an inverter circuit on the actual semiconductor substrate, layout patterns, such as p-type metal-oxide semiconductor (PMOS), n-type metal-oxide semiconductor (NMOS), N-WELL, a gate electrode, and wirings to be disposed thereon, may be appropriately arranged.

The CTS process (S14) may be a process of generating patterns of signal lines of a central clock related to a response time that determines performance of the semiconductor device.

The routing process (S15) may be a process of producing an upper wiring structure or a routing structure including power wiring patterns connecting the arranged standard cells and signal line patterns. In particular, in this process, a power distribution network (PDN) may be implemented. In the PDN, the power wiring patterns and/or the signal line patterns may be electrically connected to the wirings in the standard cells. In addition, the standard cells may be electrically connected to each other by the power wiring patterns and/or the signal line patterns.

The what-if-analysis process (S16) may be a process of verifying and correcting the generated layout. Items to be verified may include a design rule check (DRC) process verifying whether the layout is generated to be appropriate to the design rule, an electrical rule check (ERC) process verifying whether the layout is appropriately generated without electrical disconnection therein, and a layout vs. schematic (LVS) checking whether the layout matches the schematic.

In an embodiment, the what-if-analysis process (S16) may include a PDN verification process verifying whether the PDN is appropriately connected with the lowest resistance. The PDN verification process may be carried out through the LVS verification. The PDN verification process is described later.

The above processes to design the layout may be implemented by the layout design system, for example, the processor 20, and the processor 20 may include a processor 21, a design module 23, and an analyzer 25. The processor 20 may include the storage 30 therein according to embodiments.

The processor 21 may be used by the design module 23 and/or the analyzer 25 to perform calculations. As an example, the processor 21 may include one or more of a central processor (CPU), a micro-processor, an application processor (AP), a digital signal processor (DSP), a graphic processor (GPU), or the like. The processor 21 may be a programmable logic device (PLD) including a field programmable gate array (FPGA), a field programmable analog array (FPAA), or the like. FIG. 2 shows only one processor 21, however, the layout design system may include a plurality of processors 21. The processor 21 may include cache memories to increase computation capacity.

The storage 30 may include first standard cell library 31_1, a second standard cell library 31-2, and a third standard cell library 31_3 and may further include a design rule 33. The first, second, and third standard cell libraries 31_1, 31_2, and 31_3 and the design rule 33 may be provided to the design module 23 and/or the analyzer 25 from the storage 30. The first, second, and third standard cell libraries 31_1, 31_2, and 31_3 may include standard cells with different cell heights, different cell sizes, different circuit specifications, different circuit configurations, different routing track widths, etc. According to embodiments, the number of the standard cell libraries included in the storage 30 may be changed in various ways.

The design module 23 may include a placer 23_1 and a router 23_2. Herein, the term “module” may indicate, but is not limited to, a software, a hardware, such as a field programmable gate array (FPGA) or an application specific integrated circuit (ASIC), or a combination of the software and the hardware. A module may be configured to reside in a tangible addressable storage medium in the form of software and may be configured to execute on one or more processors 21. The placer 23_1 and the router 23_2 may be used to perform the placement process (S13) and the routing process (S15). For instance, the processor 21 may execute a layout design tool, e.g., a P&R tool, to perform the placement process (S13) and the routing process (S15). The placer 23_1 may place or arrange, using the processor 21, the standard cells based on input data and the first, second, and third standard cell libraries 31_1, 31_2, and 31_3, which are included in an integrated circuit. In particular, the placer 23_1 may place the standard cells from the first, second, and third standard cell libraries 31_1, 31_2, and 31_3 in each circuit function block. The router 23_2 may perform a signal routing with respect to the placement of the standard cells provided from the placer 23_1. According to embodiments, the placer 23_1 and the router 23_2 may be implemented as separate and distinct modules. In addition, the design module 23 may further include components to perform the CTS process (S14) in addition to the placer 23_1 and the router 23_2.

The analyzer 25 may analyze and verify a result of the placement and the signal routing. In a case where it is determined based on the result of the analysis that the routing is not completed successfully, the placer 23_1 may modify a previous cell placement, and the router 23_2 may perform the signal routing with respect to the modified cell placement. In a case where it is determined based on the result of the analysis that the routing is successfully completed, the router 23_2 may provide output data defining the integrated circuit.

The design module 23 and/or the analyzer 25 may be implemented in software, but embodiments are not limited thereto. In the case where both the design module 23 and the analyzer 25 are implemented in software, the design module 23 and the analyzer 25 may be stored in the form of a code in the storage 30 or may be stored in the form of a code in another storage separate from the storage 30.

According to the above layout design system and the design method using the layout design system, it is necessary to perform the PDN verification process in the what-if-analysis process. This is to verify power integrity when the PDN is applied to a semiconductor device, for example, a system-on-chip (SoC) type semiconductor device. The power integrity may be determined by a connection relationship between a power and bumps corresponding to a ground source and a resistance value applied thereto.

The layout design method according to embodiments may provide the layout that minimizes the resistance value of the PDN connected to the bumps and the PDN verification process that more efficiently verifies the integrity of the layout. For example, the PDN verification process may provide a semiconductor layout that enables the PDN to have the lowest resistance when connecting the PDN to the bump.

According to an embodiment, the PDN verification process may be performed using an LVS engine in the analyzer 25.

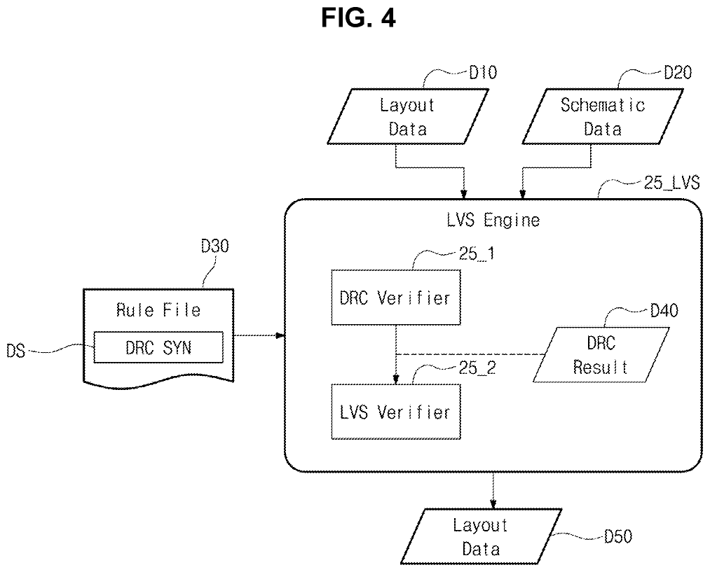

FIG. 4 is a block diagram illustrating the LVS engine 25_LVS in the analyzer 25 of FIG. 2.

Referring to FIG. 4, the LVS engine 25_LVS may be a program that performs the LVS verification on various circuits. The LVS engine 25_LVS may include a program that performs a verification operation on a connection relationship between the PDN and the bumps. The LVS engine 25_LVS may include multiple procedures such as a DRC verifier 25_1 and an LVS verifier 25_2. In this case, each of the procedures may denote a series of instructions for performing a certain task and may be referred to as a function, a routine, a subroutine, or a subprogram. According to embodiments, the operation of the processor 21 performed by executing the procedure stored in the storage 30 may be referred to as the operation executed by the procedure itself.

The LVS engine 25_LVS may receive layout data D10 and schematic data D20. The layout data D10 may be topological data with respect to the layout of the integrated circuit. The integrated circuit may have a structure in which multiple layers are stacked through a semiconductor manufacturing process, and the layout data D10 of the integrated circuit may include topological information of the multiple layers. The multiple layers may include a conductive wiring layer and an insulating layer, and elements of the integrated circuit may be configured as a pattern formed in one or more wiring layers.

The schematic data D20 may include information about elements, such as a transistor, a resistor, a diode, etc., and may define a connection relationship between the elements. For example, in the schematic data D20, the elements of the integrated circuit may be defined as instances of corresponding symbols in the schematic data, and the instances may be connected to each other through wirings. The same symbols may define elements that perform the same function. For example, each element, such as an NMOS transistor, a PMOS transistor, a diode, a resistor, etc., may be defined as a unique symbol. As an example, the schematic data D20 may include a netlist of a transistor level, a netlist of a gate level, a netlist of a cell level, or a netlist of an intellectual property level.

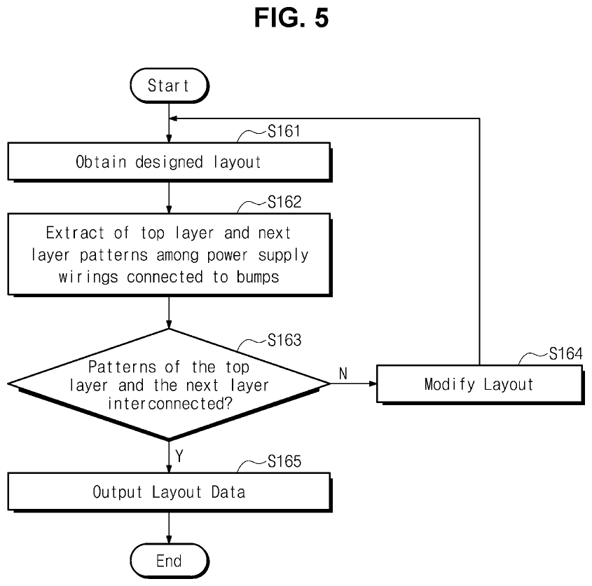

FIG. 5 is a flowchart illustrating the PDN verification process in the above-described layout design method in reference to FIGS. 3 and 4 according to embodiments. The PDN verification process is to check whether the layout of the actual semiconductor device is designed to allow the PDN to have the lowest resistance when the PDN is connected to the bump. The PDN verification process may be performed by the LVS verification using the LVS engine and only the schematic data related to the power wiring patterns may be extracted to perform the PDN verification.

In FIG. 5, the PDN verification process may include obtaining the layout in which the power wiring patterns are included (S161), extracting a top layer wiring pattern and a next-top layer wiring pattern among lines of the power wiring patterns, which are connected to the bumps (S162), determining whether the top layer wiring pattern is connected to the next-top layer wiring pattern (S163), modifying the layout when the top layer wiring pattern and the next-top layer wiring pattern are not interconnected (S164), and outputting the layout data when the top layer wiring pattern and the next-top layer wiring pattern are interconnected (S165).

For example, the designed layout in which the power wiring patterns are included may be obtained. In this process, the designed layout refers to the layout in which the power wiring patterns are designed by carrying out the powerplan process, the placement process, and the routing process described above with reference to FIGS. 2 and 3.

Then, the bumps and the wiring patterns to apply a power voltage and/or a ground voltage may be extracted from the designed power wiring patterns, and the top layer wiring pattern and the next-top layer wiring pattern may be extracted from the wiring patterns connected to the bumps. In this case, the top layer wiring pattern and the next-top layer wiring pattern may respectively indicate the wiring pattern connected to the bumps and disposed in a layer that is the most adjacent to the bumps and the wiring pattern connected to the bumps and disposed in a layer that is the second-most adjacent to the bumps in the semiconductor device with the multiple layers. For example, when the bumps are placed at the uppermost position, a first wiring pattern provided in the layer immediately below the bumps and connected to the bumps may be the top layer wiring pattern, and a second wiring pattern provided in the layer immediately below the top layer wiring pattern and connected to the top layer wiring pattern may be the next-top layer wiring pattern. Hereinafter, the first wiring pattern and the top layer wiring pattern are interchangeably used, and the second wiring pattern and the next-top layer wiring pattern are interchangeably used.

Then, a process of determining whether the extracted top layer wiring pattern and the extracted next-top layer wiring pattern are interconnected.

In the PDN, the structure that the top layer wiring pattern and the next-top layer wiring pattern are interconnected indicates that the top layer wiring pattern and the next-top layer wiring pattern are connected by the shortest path between the bumps adjacent to each other and a resistance of the wirings between two bumps is minimum.

In the case where it is determined that the top layer wiring pattern and the next-top layer wiring pattern are interconnected in the designed layout, this layout may pass the PDN verification. The layout verified through the PDN verification may be output as a final layout data, and the PDN verification process may be finished.

In the case where it is determined that the top layer wiring pattern and the next-top layer wiring pattern are not interconnected in the designed layout, the designed layout may be modified. The modification of the layout may indicate modifying the connection relationship between the top layer wiring pattern and the next-top layer wiring pattern, which are connected to the bumps. To this end, a portion of the layout, particularly, the top layer wiring pattern and the next-top layer wiring pattern, may be modified using the design module in at least one process among the powerplan process, the placement process, and the routing process.

Hereinafter, the modification of the layout will be described in detail with reference to drawings showing the semiconductor device.

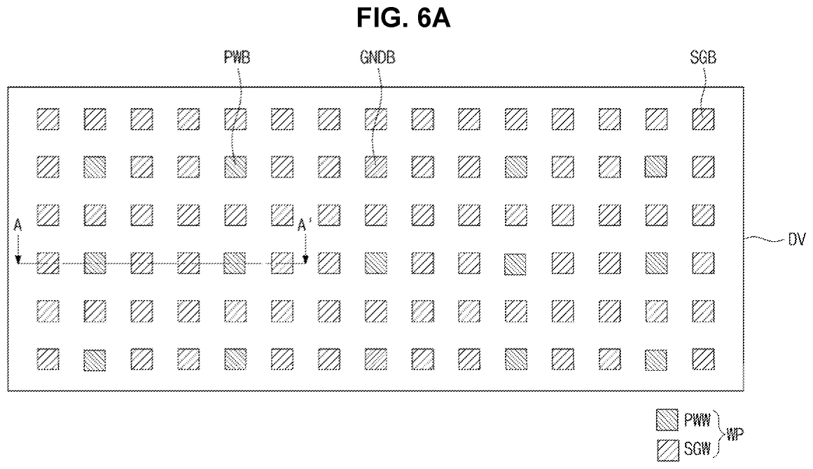

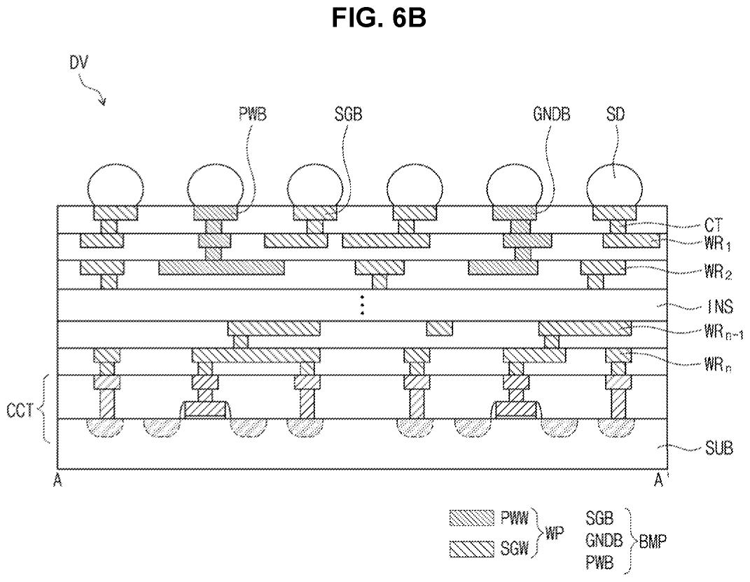

FIGS. 6A and 6B are views conceptually illustrating a relationship between bumps BMP and wirings in a semiconductor device DV having multiple layers. FIG. 6A is a plan view, and FIG. 6B is a cross-sectional view taken along a line A-A′ of FIG. 6A.

Referring to FIGS. 6A and 6B, the semiconductor device DV may include a substrate SUB, a circuit part CCT disposed on the substrate SUB, and a wiring part WP connected to the circuit part CCT. The wiring part WP may include a power wiring part PWW to apply a power voltage and/or a ground voltage and a signal wiring part SGW to transmit various signals except the power voltage and/or the ground voltage.

The semiconductor device DV may include the bumps BMP connected to the power wiring part PWW and the signal wiring part SGW. A conductive connection member, such as a solder SD, may be provided to the bumps BMP, and thus the bumps BMP may be connected to other external components. Various signals including the power voltage and the ground voltage may be transmitted from external devices to the semiconductor device DV or from the semiconductor device DV to the external devices through the bumps BMP.

According to embodiments, the bumps BMP may be provided on an upper surface of the semiconductor device DV. The bumps BMP may include bumps connected to the power wiring part PWW and bumps connected to the signal wiring part SGW. The bumps BMP connected to the power wiring part PWW may include power bumps PWB connected to power patterns and ground bumps GNDB connected to ground patterns.

The bumps BMP connected to the power wiring part PWW and the bumps BMP connected to the signal wiring part SGW may be arranged in various ways when viewed from a plan view. The bumps BMP connected to the power wiring part PWW may be arranged spaced apart from each other at a predetermined interval to uniformly apply the power voltage and the ground voltage to the entire PDN. As an example, each of the power bumps PWB and/or the ground bumps GNDB may be arranged spaced apart from each other at the predetermined interval, and the power bumps PWB may be alternately arranged with the ground bumps GNDB in the same column and the same row. However, the arrangement of the wiring part WP connected to the bumps BMP should not be limited thereto or thereby and may be changed in various ways.

The wiring part WP of the semiconductor device DV may include wiring patterns WR₁, WR₂, WR₃, . . . , WRₙ₋₁, and WRₙ formed in multiple layers with insulating layers INS. The multiple layers may be provided in at least two layers or more, and as an example, the wiring part WP may include the wiring patterns WR₁, WR₂, WR₃, . . . , WRₙ₋₁, WRₙ provided in n layers (n is two or more). Each wiring pattern may be provided in a corresponding layer of the multiple layers, and in this case, the wiring patterns respectively formed in the layers may be sequentially referred to as first to n-th wiring patterns WR₁, WR₂, WR₃, . . . , WRₙ₋₁, WRₙ from a layer disposed immediately under the uppermost position where the bumps BMP are formed.

The wiring patterns of the wiring part WP of the semiconductor device DV may include wirings extending in different directions alternately according to the layer. As an example, odd-numbered wiring patterns may include wirings extending in one direction, and even-numbered wiring patterns may include wirings extending in a direction intersecting the one direction. As an example, when viewed in the plane, the odd-numbered wiring patterns may include wirings extending in up-and-down directions, and the even-numbered wiring patterns may include wirings extending in left-and-right directions.

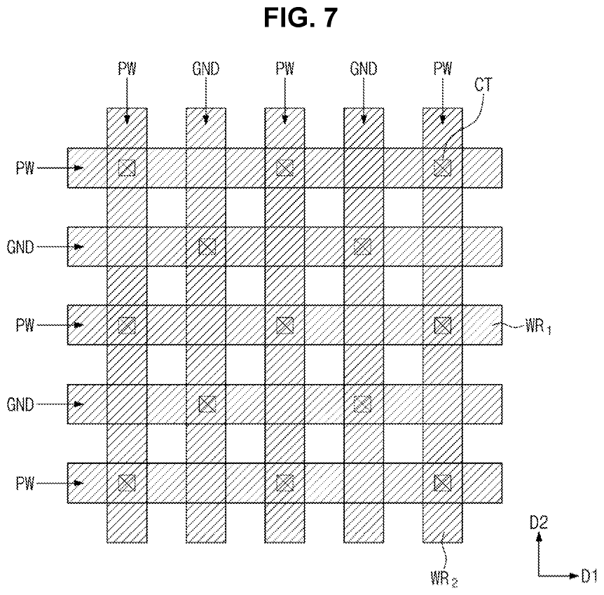

FIG. 7 is a plan view conceptually illustrating the power wiring part PWW of the semiconductor device DV except the signal wiring part SGW according to embodiments.

Referring to FIG. 7, the top layer wiring pattern WR1 may include a plurality of wirings extending in the one direction, for example, the first direction D1, and the next-top layer wiring pattern WR2 may include a plurality of wirings extending in the direction that intersects the one direction, for example, the second direction D2. The power voltage PW and the ground voltage GND may be alternately applied to the wirings forming the top layer wiring pattern WR1 and may be alternately applied to the wirings forming the next-top layer wiring pattern WR2.

In the embodiment, the wirings of the top layer wiring pattern WR₁ to which the power voltage PW is applied may be connected to the wirings of the next-top layer wiring pattern WR₂ to which the power voltage PW is applied via contacts CT to form a network. The power bumps may be connected to the wirings of the top layer wiring pattern WR₁ to which the power voltage PW is applied.

The wirings of the top layer wiring pattern WR₁ to which the ground voltage GND is applied may also be connected to the wirings of the next-top layer wiring pattern WR₂ to which the ground voltage GND is applied via contacts to form a network. The ground bumps may be connected to the wirings to which the ground voltage GND applied in the top layer wiring pattern WR₁.

The bumps BMP (refer to FIGS. 6A and 6B) may be disposed on the wirings forming the top layer wiring pattern WR₁ and the wirings forming the next-top layer wiring pattern WR₂ and may be connected to the top layer wiring pattern WR₁.

When the top layer wiring pattern WR₁ and the next-top layer wiring pattern WR₂ are interconnected as shown in FIG. 7, the resistance caused by the wirings between the bumps BMP coupled to the wirings of the two power supply units is minimized since the top layer wiring pattern WR₁ and the next-top layer wiring pattern WR₂ are connected by the shortest path between the bumps BMP coupled to the wirings of the two power supply units adjacent to each other.

According to embodiments, the process of verifying is performed to verify whether the designed layout corresponds to the PDN structure described above, that is, to verify whether the resistance caused by the wirings between the bumps BMP coupled to the wirings of the two power supply units is minimized. In this case, the structure of the semiconductor device corresponding to the layouts of “pass” and “fail” after the verification are as follows.

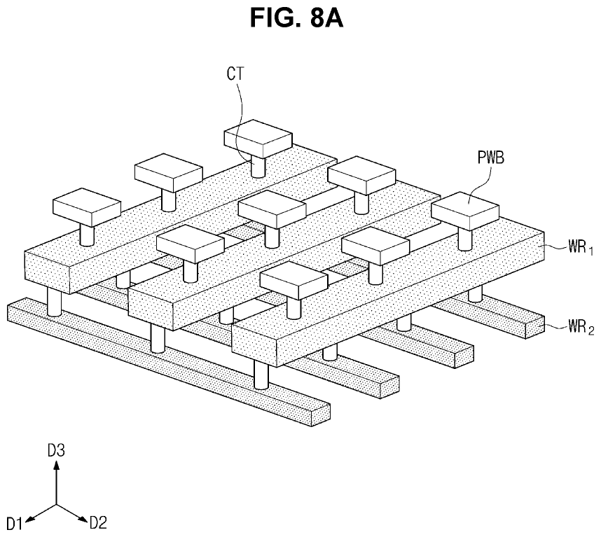

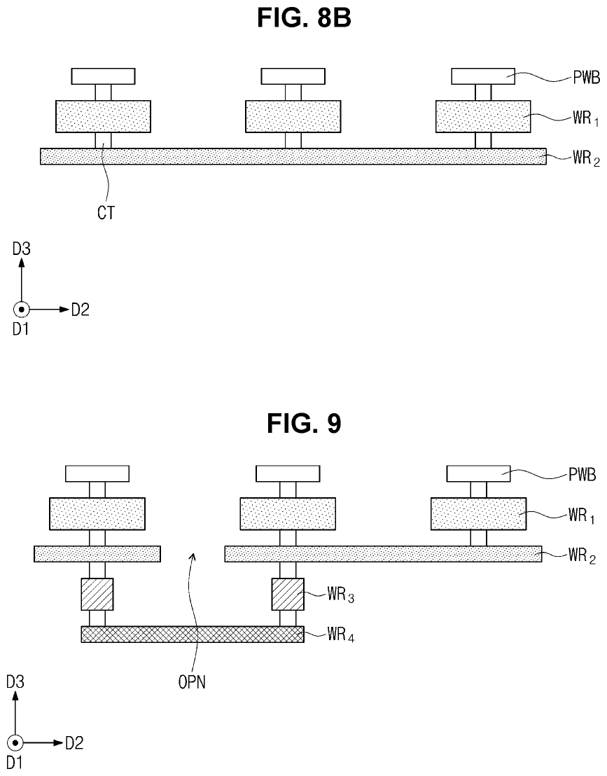

FIGS. 8A and 8B are a perspective view and a cross-sectional view conceptually illustrating a layout of the power pattern for each layer when the designed layout passed the verification process according to embodiments. FIG. 9 is a perspective view and a cross-sectional view conceptually illustrating a layout of the power pattern for each layer when the designed layout failed the verification process according to embodiments. In the embodiment, only the power pattern among the power wiring patterns of the power supply unit is shown. Since the ground pattern may have substantially the same connection structure and the verification method as the power pattern, details thereof will not be repeated.

Referring to FIGS. 8A and 8B, the top layer wiring pattern WR₁ and the next-top layer wiring pattern WR₂ may be interconnected.

The power bumps PWB may be arranged in a matrix form. The first wiring pattern WR₁ may be provided under the power bumps PWB. The wirings of the first wiring pattern WR₁ may extend in the first direction D1. The second wiring pattern WR₂ may be provided under the first wiring pattern WR₁. The wirings of the second wiring pattern WR₂ may extend in the second direction D2. The wirings of the first wiring pattern WR₁ extending in the first direction D1 and the wirings of the second wiring pattern WR₂ extending in the second direction D2 may be connected to each other via the contacts CT, and the wirings of the first wiring pattern WR₁ may be connected to the power bumps PWB via the contacts CT. As described above, the power bumps PWB may be connected to each other via the wirings of the first wiring pattern WR₁ and the second wiring pattern WR₂, and a resistance of the power pattern may be minimized.

Referring to FIG. 9, not all of the top layer wiring pattern WR1 and the next-top layer wiring pattern WR2 are connected to each other, and the second wiring pattern WR2 may be partially opened and disconnected. In this case, when the verification process is performed by extracting only the top layer wiring pattern WR₁ and the next-top layer wiring pattern WR₂, it is determined as a failure or an error since not all of the top layer wiring pattern WR1 and the next-top layer wiring pattern WR2 are connected to each other.

For example, some of the wirings forming the second wiring pattern WR2 extend in the second direction D2 and are partially opened OPN in some areas as shown in FIG. 9. Due to the open portion of the second wiring pattern WR₂, the wirings of the second wiring pattern WR₂ may not be electrically connected, and another wiring pattern is required to electrically connect the wirings of the second wiring pattern WR₂. Accordingly, a fourth wiring pattern WR₄ provided under the second wiring pattern WR₂ and extending in the second direction D2 may be needed, and thus, a third wiring pattern WR₃ and the fourth wiring pattern WR₄ may need to be electrically connected to each other. For example, the first, second, third, and fourth wiring patterns WR₁, WR₂, WR₃, and WR₄ may be sequentially provided under the power bumps PWB, and at least portions between the first, second, third, and fourth wiring patterns WR₁, WR₂, WR₃, and WR₄ may be connected to each other by the contacts CT to connect the open portion. Therefore, the power bumps PWB adjacent to each other are electrically connected to each other via the first wiring pattern WR₁ to the fourth wiring pattern WR₄. The resistance of the power pattern having the connection structure described above becomes larger than the case shown in FIGS. 8A and 8B and does not meet the minimum resistance condition.

As described above, when all the top layer wiring pattern WR₁ and the next-top layer wiring pattern WR₂ are not interconnected to each other, the PDN verification may be determined as “fail”.

The layout determined as “fail” through the above-described PDN verification process may be modified so that the failed layout is changed to the structure determined as “pass”, for example, the power bumps PWB are connected to each other by only the wirings of the first wiring pattern WR₁ and the second wiring pattern WR₂. The connection relationship between the power bumps PWB and the wirings of the first wiring pattern WR₁ and the second wiring pattern WR₂ of the modified layout may be verified again through the PDN verification process.

As described above, the wiring patterns of only two layers connected to the bumps are extracted to verify whether the bumps are connected to the wiring patterns of the two layers, and thus, it is possible to more easily build the PDN that meets the lowest resistance condition. According to related art, it is necessary to check not only the wiring patterns of some layers connected to the bumps but also the connectivity of the wirings for the entire layers forming the semiconductor device, and as a result, it may be difficult to obtain the minimum resistance of the layout of the PDN.

More than thousands of power/ground bumps may be used in various semiconductor devices, e.g., a system-on-chip type semiconductor device, and maintaining the shortest path between the bumps in the connection relationship of the bumps is a major way to reduce the resistance of power wirings and ground wirings. In the case where the semiconductor device includes the wiring patterns in the multiple layers, the wiring patterns adjacent to each other may have directionalities intersecting with each other. Accordingly, in the embodiments, the lowest resistance of the power wirings and the ground wirings may be more easily achieved by extracting only the wiring patterns of the top layer and the wiring patterns of the next-top layer and verifying only the interconnectivity with the bump. In the case where it is determined as “fail” in the PDN verification process, the connectivity between the wiring pattern of the top layer and the wiring pattern of the next-top layer may be easily secured by checking the failed point.

In the above-described embodiments, the method of designing the layout of the PDN that extracts only the wiring patterns of the top layer and the next-top layer and verifies the connection relation between the wiring patterns and the bumps are described, however, embodiments are not limited thereto or thereby.

Extracting only the wiring patterns of the top layer and the next-top layer and verifying the interconnection relationship may ensure the lowest resistance if there are no other conditions, however, when designing the actual wiring patterns, open portions may occur within the wiring patterns of the top layer and the next-top layer due to restrictions based on design rules. For example, the occurrence of the open portions may occur in situations where semiconductor devices are becoming smaller and more complex, and in this case, the wiring structure may also require connection to various layers.

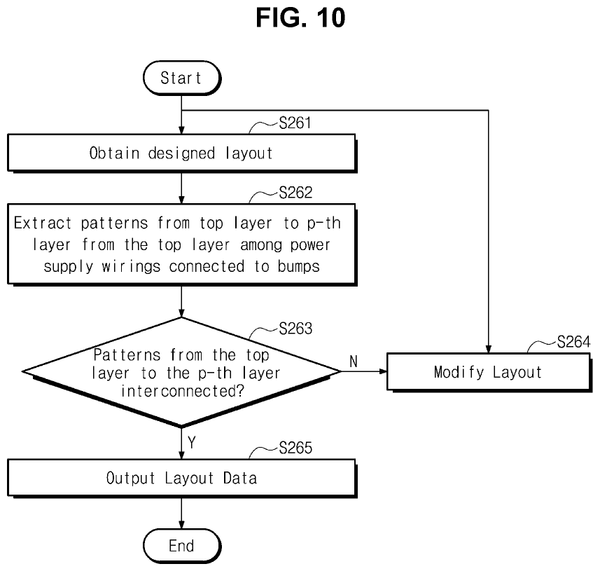

FIG. 10 is a flowchart illustrating a PDN verification process when there is an open portion in wiring patterns of a top layer and a next-top layer according to embodiments.

Referring to FIG. 10, the PDN verification process may include obtaining a layout including power wiring patterns (S261), extracting from a first wiring pattern to a p-th wiring pattern when the open portion exists in wirings connected to bumps from the first wiring pattern to a (p−2)th wiring pattern in the power wiring patterns (S262), and determining whether the top layer wiring pattern and the p-th wiring pattern are interconnected (S263).

Depending on whether the top layer wiring pattern and the p-th wiring pattern are interconnected, modifying of the layout may be performed when the top layer wiring pattern and the p-th wiring pattern are not interconnected (S264), and outputting of layout data may be performed when the top layer wiring pattern and the p-th wiring pattern are interconnected (S265). In the embodiment, a semiconductor device includes n layers, and the “p” is a natural number greater than three and equal to or smaller than the “n”.

The p-th wiring pattern may correspond to a wiring pattern that is two levels lower than the wiring pattern where there is the open portion. Since the wiring patterns formed in the multiple layers extend alternately in directions intersecting each other for each layer, a wiring pattern, which is disposed two layers lower than the wiring pattern with the open portion and extends in the same direction as the wiring pattern with the open portion, is required to connect the wiring pattern with the open portion. For example, in a case where the wiring pattern with the open portion corresponds to the (p−2)th wiring pattern, the interconnectivity may be verified from the first wiring pattern to the p-th wiring pattern, which is disposed two layers lower than the (p−2)th wiring pattern with the open portion, via the (p−2)th wiring pattern. As an example, in a case where the open portion occurs in the first wiring pattern, the interconnectivity may be verified from the first wiring pattern to a third wiring pattern. In a case where the open portion occurs in the second wiring pattern, the interconnectivity may be verified from the first wiring pattern to a fourth wiring pattern.

According to the embodiment, even though the wiring is opened, it is possible to more easily build a PDN network that meets the lowest resistance conditions by further extracting and verifying only the wiring patterns of two layers disposed under the wiring pattern including the opened wiring.

When the what-if-analysis process is completed through the above-described method, the designing process of the layout of the semiconductor device may be completed, the semiconductor device manufacturing process may be performed to manufacture the semiconductor device based on the designed layout. Hereinafter, the manufacturing method of the semiconductor device will be mainly described in addition the designing of the layout of the semiconductor device.

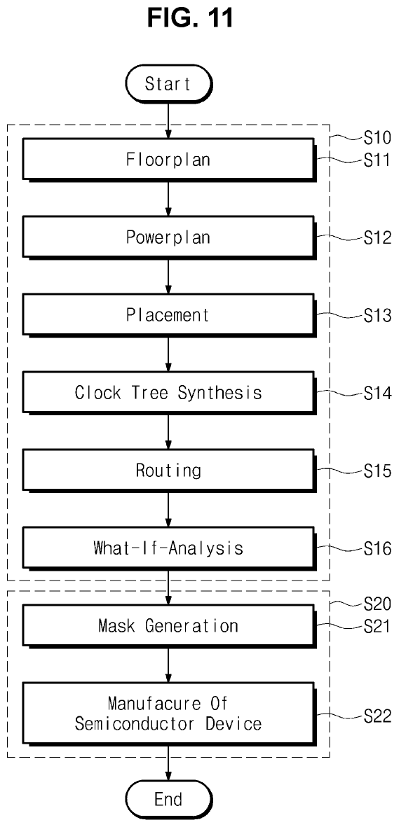

FIG. 11 is a flowchart illustrating a method of manufacturing a semiconductor device according to embodiments.

As described above, when the designing of the layout of the semiconductor device is completed (S10), the manufacturing process of the semiconductor device may be performed (S20). The manufacturing process of the semiconductor device may be performed based on the designed layout in a semiconductor process module (S20).

The manufacturing process of the semiconductor device (S20) may include generating a mask (S21) and manufacturing the semiconductor device (S22).

The generating of the mask (S21) may include performing an optical proximity correction (OPC) on the layout data generated in the designing of the semiconductor device (S10) to generate mask data used to form various patterns in the multiple layers and manufacturing the mask using the mask data. The optical proximity correction (OPC) may be performed to correct a distortion phenomenon generated in a photolithography process. The mask may be manufactured by depicting the layout patterns using a chrome thin film applied on a glass or quartz substrate.

In the manufacturing of the semiconductor device (S22), various types of exposure and etching processes may be performed repeatedly. Through these processes, the shapes of the patterns designed during the designing of the layout may be sequentially formed on a silicon substrate. For example, various semiconductor processes may be performed on the semiconductor substrate, such as a wafer, using a plurality of masks to form the semiconductor device in which the integrated circuit is implemented. The semiconductor process may include a deposition process, an etching process, an ion process, a cleaning process, etc. In addition, the semiconductor process may include a process of packaging the semiconductor device in which the semiconductor device is mounted on a printed circuit board (PCB) and sealed with sealant and a process of testing for the semiconductor device or the package of the semiconductor device.

According to the embodiment, the PDN verification process is performed in the designing of the layout, and thus, it is possible to design and manufacture the semiconductor device including the PDN with the minimum resistance. As an example, when applying the PDN in the design of the system-on-chip (SoC) type semiconductor device, the wirings of the power supply unit, i.e., the power patterns and the ground patterns, are manufactured to have a minimum number of connection points with the bumps corresponding to the power voltage and/or the ground voltage. Accordingly, it is possible to more stably provide the power and ground voltages to the semiconductor device, and as a result, an improved performance of the semiconductor device may be ensured.

Although the embodiments have been described, it is understood that the present disclosure should not be limited to these embodiments but various changes and modifications can be made by one ordinary skilled in the art within the spirit and scope of the present disclosure as hereinafter claimed.

While embodiments have been described with reference to the figures, it will be understood by those of ordinary skill in the art that various changes in form and details may be made therein without departing from the spirit and scope as defined by the following claims and their equivalents.

What is claimed is:

1. A method of designing a layout of a semiconductor device comprising a plurality of wiring layers, the method comprising:
verifying a power distribution network, the verifying of the power distribution network comprising:
designing a layout comprising a power wiring pattern;
extracting a top layer wiring pattern and a next-top layer wiring pattern connected to bumps in the power wiring pattern;
determining whether the top layer wiring pattern and the next-top layer wiring pattern are interconnected; and
modifying the layout based on whether the top layer wiring pattern and the next-top layer wiring pattern are interconnected.

2. The method of claim 1, wherein the power wiring pattern comprises the wirings configured to apply a power voltage.

3. The method of claim 1, wherein the power wiring pattern comprises the wirings configured to apply a ground voltage.

4. The method of claim 1, wherein the designing of the layout comprises designing the wirings of the top layer wiring pattern to extend in a first direction, designing the wirings of the next-top layer wiring pattern to extend in a second direction intersecting the first direction, and designing the top layer wiring pattern to be in contact with the next-top layer wiring pattern via contacts.

5. A method of designing a layout of a semiconductor device comprising n wiring layers, where n is a natural number equal to or greater than 2, sequentially on bumps, the method comprising:
designing the layout comprising a power wiring pattern;
extracting, based on an open occurring in wirings connected to the bumps from a first wiring pattern to a (p−2)th wiring pattern, where p is a natural number greater than 3, in the power wiring pattern, the wiring patterns from the first wiring pattern to a p-th wiring pattern to determine whether the bumps are interconnected with the wiring patterns from the first wiring pattern to the p-th wiring pattern;
extracting, based on the open not occurring, the first wiring pattern and a second wiring pattern to determine whether the bumps are interconnected with the first wiring pattern and second wiring pattern; and
modifying the layout based on whether the bumps are interconnected with the first wiring pattern and second wiring pattern.

6. The method of claim 5, wherein the wiring patterns from the first wiring pattern to an n-th wiring pattern comprise the wirings that alternately extend in different directions from each other based on the wiring layers.

7. The method of claim 5, wherein the power wiring pattern comprise the wirings configured to apply a power voltage.

8. The method of claim 5, wherein the power wiring pattern comprise the wirings configured to apply a ground voltage.

9. The method of claim 5, wherein the designing of the layout comprises designing the wirings of the first wiring pattern to extend in a first direction, designing the wirings of the second wiring pattern to extend in a second direction intersecting the first direction, and designing the first wiring pattern to be in contact with the second wiring pattern via contacts.

10. A layout design system for a semiconductor device comprising a plurality of wiring layers comprising a power distribution network, comprising at least one processor configured to:
design a layout design;
verify the designed layout; and
generate verified layout data,
wherein the processor is further configured to extract a portion of wiring layers connected to bumps among the wiring layers and verify the extracted wiring layers such that the power distribution network has a minimum resistance when verifying the designed layout.

11. The layout design system of claim 10, wherein the bumps comprise bumps connected to a power wiring part and bumps connected to a signal wiring pattern, and the processor is further configured to extract and verify the bumps connected to the power wiring part.

12. The layout design system of claim 11, wherein the bumps connected to the power wiring part comprise power bumps to which a power voltage is applied, and the processor is further configured to verify whether power patterns connected to the power bumps are interconnected.

13. The layout design system of claim 11, wherein the bumps connected to the power wiring part comprise ground bumps to which a ground voltage is applied, and the processor is further configured to verify whether ground patterns connected to the ground bumps are interconnected.

14. The layout design system of claim 10, wherein the designed layout comprises:
a plurality of the bumps on a first side of the wiring layers; and
a first wiring pattern to an n-th wiring pattern, where n is a natural number equal to or greater than 2, sequentially in the wiring layers under the bumps.

15. The layout design system of claim 14, wherein the processor is further configured to extract the first wiring pattern and a second wiring pattern and verify whether the first wiring pattern and the second wiring pattern are interconnected with the bumps when verifying the designed layout.

16. The layout design system of claim 15, wherein the processor is further configured to modify the designed layout when the first wiring pattern and second wiring pattern are not interconnected with the bumps.

17. The layout design system of claim 15, wherein the processor is further configured to extract, based on an open due to a design rule occurring in wirings connected to the bumps from the first wiring pattern to a (p−2)th wiring pattern, the wiring patterns from the first wiring pattern to a p-th wiring pattern, where p is a natural number greater than 3, to verify whether the bumps are interconnected with the wiring patterns from the first wiring pattern to the p-th wiring pattern when verifying the designed layout.

18. The layout design system of claim 17, wherein the processor is further configured to modify the designed layout based on the first wiring pattern to the p-th wiring pattern not being interconnected with the bumps.

19. The layout design system of claim 10, wherein the at least one processor comprises:
a design module configured to design the layout;
an analyzer configured to verify the designed layout.

20. The layout design system of claim 19, wherein the verification of the designed layout corresponds to a layout-versus-schematic (LVS) verification.
